(19) United States
(12) Patent Application Publication
(10) Pub. No.: US 2007/0267002 A1
(43) Pub. Date: Nov. 22, 2007

(54) Internal Combustion Engine with Exhaust Gas Recirculation Device, and Associated Method

(75) Inventors: Wolfram Schmid, Nuetingen (DE); Sigfried Sumser, Stuttgart (DE); Helmut Finger, Leinfelden-Echterdingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/560,748

(22) PCT Filed: Jun. 15, 2004
(86) PCT No.: PCT/EP04/06409

§ 371 Date: Mar. 2, 2007

(30) Foreign Application Priority Data
Jun. 18, 2003 (DE) 103 27 442.1

(51) Int. Cl. F02M 25/07

(52) U.S. Cl. 123/568.17

(57) ABSTRACT

An internal combustion engine with an exhaust gas recirculation device has two cylinder groups, the exhaust gas from which can be discharged separately via a respective exhaust pipe. The recirculation line of the exhaust gas recirculation device branches off from one of the exhaust pipes and opens out into the induction section of the internal combustion engine. The cylinder groups can be operated with different power outputs, the recirculation line of the exhaust gas recirculation device branching off from the exhaust pipe of the cylinder group with a variable power output.

The invention relates to an internal combustion engine having an exhaust gas recirculation device and to a method for operating an internal combustion engine of this type, in accordance with the preamble of claims 1 and 12 respectively.

It is known from document DE 198 57 234 A1 to provide an internal combustion engine with an exhaust gas turbocharger, the exhaust gas turbine of which has two separate exhaust gas flows of different volumes, via which exhaust gas from the internal combustion engine can in each case be fed to the turbine wheel. Each exhaust gas flow is connected to the exhaust pipe from a respective cylinder bank of the internal combustion engine. The exhaust pipe via which the smaller exhaust gas flow of the turbine is supplied with exhaust gas is connected to an exhaust gas recirculation device, the recirculation line of which branches off from the corresponding exhaust pipe and opens out into the induction section of the internal combustion engine, with the result that the nitrogen oxide emissions can be reduced in particular in the part-load range. On account of the smaller dimensions of the exhaust gas flow in question, a higher exhaust gas back pressure can be set in this exhaust pipe, boosting exhaust gas recirculation into the induction section. In particular in operating ranges with a high load, it may be appropriate to increase the exhaust gas recirculation rate in order to achieve an additional reduction in the NOₓ emissions.

The invention is based on the problem of lowering the nitrogen oxide emissions in internal combustion engines with exhaust gas, recirculation by simple measures. The fuel consumption should expediently not be increased as a result.

According to the invention, this problem is achieved by an internal combustion engine having the features of claim 1 and a method for operating an internal combustion engine having the features of claim 12. The subclaims give expedient refinements.

The internal combustion engine according to the invention has at least two cylinder groups, the exhaust gas from which can be discharged separately via a respective exhaust pipe. The cylinder groups can be operated with identical or different power outputs and/or different air/fuel ratios λₖ (asymmetric operation), with the recirculation line of the exhaust gas recirculation device branching off from the exhaust pipe of the cylinder group which is or can be operated with a higher power output in at least one operating point. On account of the higher power output and/or lower λₖ, a higher exhaust gas recirculation rate is also set, with the result that the proportion of exhaust gas recirculated into the induction section in the gas stream to be fed to the cylinders, comprising combustion air and exhaust gas, can be increased. If an identical power is to be generated in each cylinder group, a lower λₖ is obtained by suitable throttling on the air side.

Since the increased exhaust gas discharge in particular when using an exhaust gas turbocharger in the exhaust section leads to an increased exhaust gas back pressure in the associated exhaust pipe upstream of the turbine of the charger, it is possible to carry out exhaust gas recirculation even in operating ranges of the internal combustion engine in which sufficient recirculation has not been possible in the prior art. Irrespective of the form of turbine, in this embodiment exhaust gas recirculation is possible in wide operating ranges, with the result that the NOₓ emissions can be reduced.

The higher power output in a cylinder group is advantageously realized by increasing the specific power of the cylinders of this cylinder group. The cylinder groups may, for example, be operated with different air/fuel ratios, with the recirculation line of the exhaust gas recirculation device branching off from the exhaust pipe of the cylinder group which is fired with a lower air/fuel ratio; on account of the higher proportion of fuel, the cylinders of this cylinder group generate a higher specific power than the cylinders of the cylinder group which are fired with a higher air/fuel ratio. The increased specific cylinder power leads to a higher exhaust gas discharge, which can advantageously be used for exhaust gas recirculation.

In extreme circumstances with the present exhaust gas aftertreatment system, the cylinder group which participates in the exhaust gas recirculation in particular has an air/fuel mix which is below the stoichiometric value. The other cylinder groups—generally one remaining cylinder group—by contrast have a higher air/fuel mix than the cylinder group involved in the exhaust gas recirculation, in particular an air/fuel mix which is above the stoichiometric value. On average of all the cylinder groups, an air/fuel mix with a mean value is established, in particular with a stoichiometric value in the case of spark-ignition engines, so that overall on average the power density per cylinder remains the same, and on account of the lower fuel consumption of the cylinder group which is not involved in the exhaust gas recirculation, the overall fuel consumption is also not increased.

The increase or reduction in the specific power of the cylinders of one cylinder group can also be achieved by further engine measures to be carried out in addition or as an alternative to the setting of the air/fuel mix, such as for example altered ignition points or altered profiles of the fuel injection (offset start and/or offset finish of injection and/or altered injection pressure).

The internal combustion engine advantageously has a total of just two cylinder groups, one of which is involved in the exhaust gas recirculation while the second is not connected to the exhaust gas recirculation. However, it may also be expedient to provide a plurality of cylinder groups each having a respective exhaust pipe and for one or more cylinder groups to be involved in the exhaust gas recirculation and/or one or more cylinder groups to be made independent of the exhaust gas recirculation, with the cylinder groups involved in the exhaust gas recirculation outputting a higher power than the other cylinder groups.

As an alternative or in addition to the increased specific cylinder power described above, the higher power output in a cylinder group can also be achieved by providing a different number of cylinders in the cylinder groups. By way of example, the cylinder group involved in the exhaust gas recirculation may have a higher number of cylinders and therefore produce more exhaust gas than the cylinder group which is not involved in the exhaust gas recirculation. It is in this way likewise possible to implement asymmetric engine operation.

On the other hand, however, in particular in combination with an increased specific cylinder power, it may also be advantageous for the cylinder group which interacts with the exhaust gas recirculation device to comprise a smaller number of cylinders than the further cylinder group which is designed to be independent of the exhaust gas recirculation device. As a result, the higher fuel consumption in the cylinder group with higher specific cylinder power involved in the exhaust gas recirculation can be compensated or even over compensated for by the lower fuel consumption in the cylinder group with a lower specific cylinder power which is not involved in the exhaust gas recirculation, so that the total fuel consumption of the internal combustion engine remains constant or may even drop.

Both single-flow exhaust gas turbines and multi-flow exhaust gas turbines are suitable. In the case of single-flow exhaust gas turbines, the turbine wheel has one single exhaust gas flow connected upstream of it, with at least the exhaust pipe from which the recirculation line of the exhaust gas recirculation device branches off opening out into this single exhaust gas flow. In particular in the case of multi-flow exhaust gas turbines, it is expedient to provide exhaust gas flows of different sizes, in which case the smaller exhaust gas flow is connected to the exhaust pipe involved in the exhaust gas recirculation and the larger exhaust gas flow is connected to the exhaust pipe of the cylinder group which is not involved in the exhaust gas recirculation. On account of the different dimensions of the exhaust gas flows, a higher exhaust gas back pressure is established in the smaller exhaust gas flow, which can advantageously be utilized for the exhaust gas recirculation. By contrast, a lower exhaust gas back pressure prevails in the exhaust pipe which opens out into the larger exhaust gas flow, so that the cylinders of the associated cylinder group have to perform less exhaust work, which leads to a favorable consumption in this cylinder group.

The exhaust gas turbine may be equipped with a variable turbine geometry in order to adjustably set the active turbine inlet cross section. In particular in the case of two-flow exhaust gas turbines, it is conceivable both to set the turbine inlet cross section of the smaller exhaust gas flow and to set the turbine inlet cross section of the larger exhaust gas flow, or the turbine inlet cross section of both exhaust gas flows. Setting the inlet cross section of the smaller exhaust gas flow offers the additional advantage that the exhaust gas recirculation rate can be influenced by the position of the variable turbine geometry.

In the method according to the invention for operating an internal combustion engine having an exhaust gas recirculation device, two cylinder groups of the internal combustion engine are operated with an identical or different power output, the cylinder group whose exhaust pipe is connected to the recirculation line of the exhaust gas recirculation device being operated with a variable power output.

Further advantages and expedient embodiments are given in the further claims, the description of the figures and the drawings, in which:

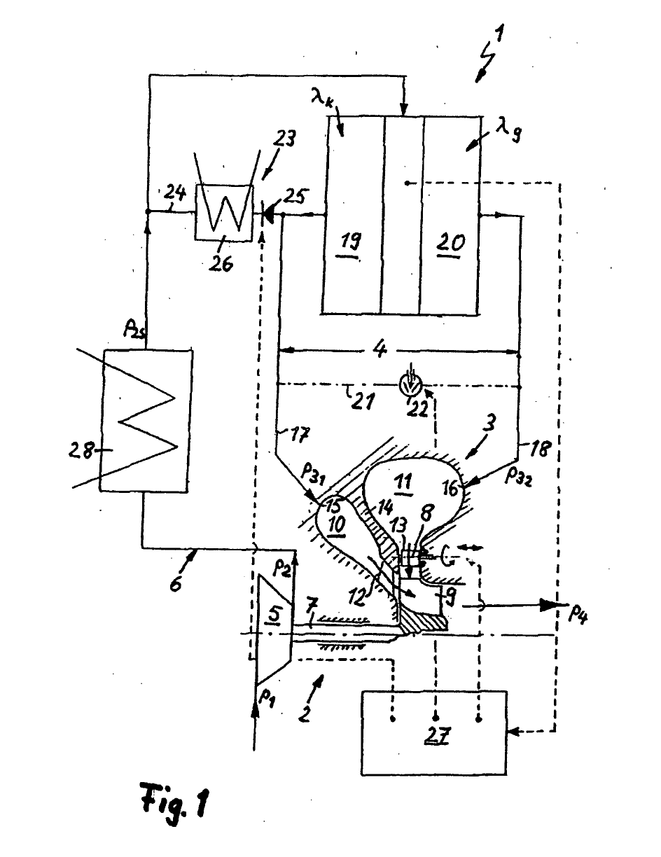

FIG. 1 diagrammatically depicts a supercharged internal combustion engine with exhaust gas recirculation, the internal combustion engine having two cylinder groups which can be operated with different air/fuel ratios, and the recirculation line of the exhaust gas recirculation branching off from one of the two exhaust pipes of the two cylinder groups,

FIG. 2 shows an enlarged illustration of a two-flow turbine with a variable turbine geometry arranged in both turbine inlet cross sections, which can also be used for the function of turbobraking,

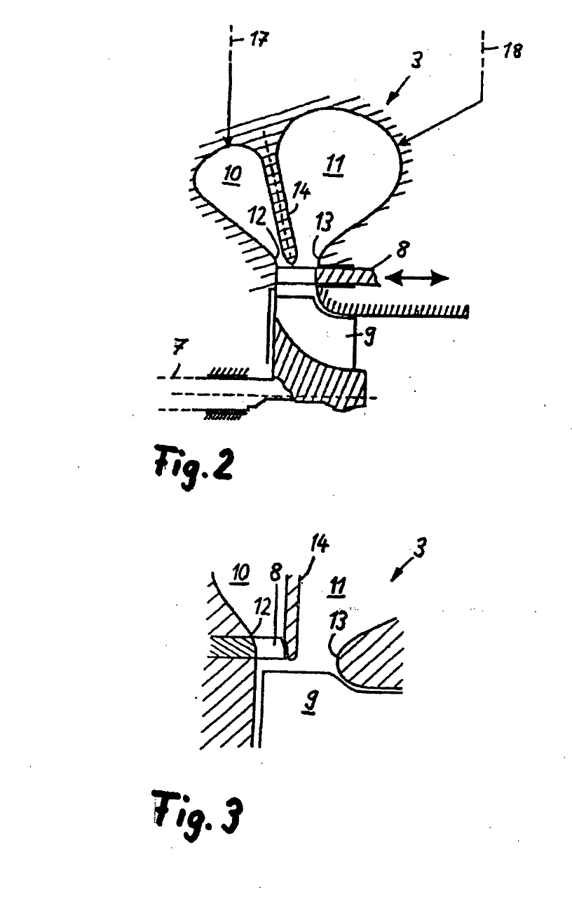

FIG. 3 shows in detail the radial turbine inlet cross section of a turbine with variable turbine geometry in the bearing-side turbine wheel inlet cross section,

FIG. 4 shows a graph illustrating various pressure profiles in the induction section and in the exhaust pipes of the cylinder groups as a function of the engine speed, with the pressure profiles in the exhaust pipes in each case illustrated for a symmetric engine operating mode and for an asymmetric engine operating mode,

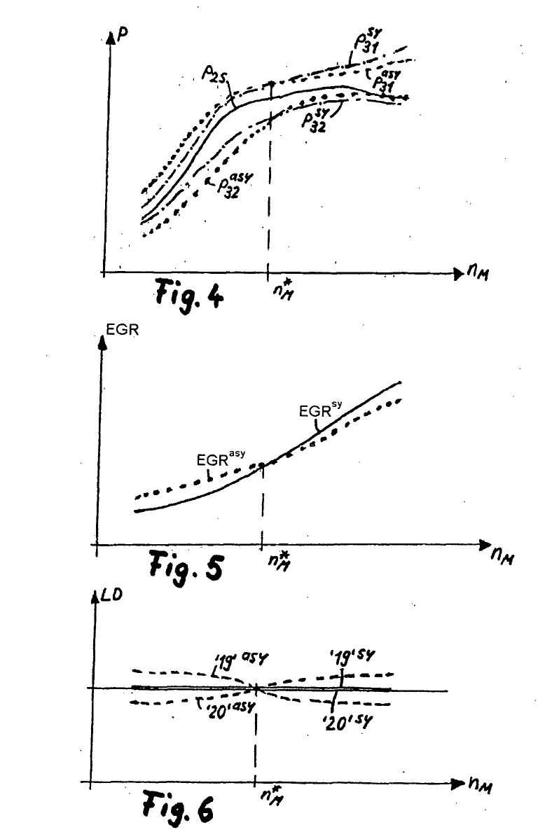

FIG. 5 shows a graph illustrating the exhaust gas recirculation rate of the exhaust pipe involved in the exhaust gas recirculation for an asymmetric engine operating mode compared to the symmetric engine operating mode as a function of the engine speed,

FIG. 6 shows a graph illustrating the deviation in the power of the cylinder groups in an asymmetric engine operating mode compared to the symmetric engine operating mode as a function of the engine speed.

In the figures, identical components are provided with identical reference designations.

The internal combustion engine 1 illustrated in FIG. 1—a spark-ignition engine or a diesel engine—of a motor vehicle comprises an exhaust gas turbocharger 2 with a turbine 3 in the exhaust section 4 and with a compressor 6 in the induction section 6, the movement of the turbine wheel being transmitted via a shaft 7 to the compressor wheel of the compressor 5. The turbine 3 of the exhaust gas turbocharger 2 is equipped with a variable turbine geometry 8, by means of which the active turbine inlet cross section to the turbine wheel 9 can be set variably as a function of the state of the internal combustion engine. The turbine 3 is designed as a two-flow combination turbine with two inflow passages or exhaust gas flows 10 and 11, of which a first exhaust gas flow 10 has a semi-axial turbine inlet cross section 12 with respect to the turbine wheel 9 and the second exhaust gas flow 11 has a radial turbine inlet cross section 13 to the turbine wheel 9. The two exhaust gas flows 10 and 11 are separated by a partition 14 fixed to the housing and are shielded from one another in a pressure-tight manner.

The variable turbine geometry 8 is expediently located in the radial turbine inlet cross section 13 of the exhaust gas flow 11 and is designed in particular as a guide grating with adjustable guide vanes or as a guide grating which can be slid axially into the radial turbine inlet cross section 13, with a variably adjustable turbine inlet cross section to the turbine wheel 9 being opened up as a function of the position of the guide grating.

Each flow 10 or 11 is provided with an inflow connection 15 or 16, respectively. Exhaust gas can be fed separately to the associated exhaust gas flow 10 or 11 via each inflow connection 15 or 16, respectively. The exhaust gas supply takes place via two exhaust pipes 17 and 18 which are formed independently of one another and form part of the exhaust section 4. Each exhaust pipe 17 or 18 is assigned to a defined number of cylinder outlets from the internal combustion engine. In the exemplary embodiment, the internal combustion engine is of V-shaped design and has two cylinder banks or groups 19 and 20, the number of cylinders in which may be identical but in particular may also be different (asymmetric internal combustion engine). The first exhaust pipe 17 leads from its associated cylinder group 19 to the first exhaust gas flow 10, and the second exhaust pipe 18 leads from the second cylinder group 20 to the second exhaust gas flow 11.

Upstream of the turbine 3, a connecting bridging line 21 with an adjustable blow-off or bypass valve 22 is arranged between the two exhaust pipes 17 and 18. The bypass valve 22 can be set to a blocking position, in which the bridging line 21 is blocked and pressure exchange between the exhaust pipes 17 and 18 is not possible, a passage position, in which the bridging line is open and pressure exchange is possible, and a blow-off position, in which exhaust gas from one of the two exhaust pipes or from both exhaust pipes is discharged from the exhaust section bypassing the turbine (not shown).

Furthermore, there is an exhaust gas recirculation device 23, which comprises a recirculation line 24 between the first exhaust pipe 17 and the induction section 6 immediately upstream of the cylinder inlet of the internal combustion engine 1 and a blocking valve 25 or nonreturn valve or butterfly valve, which can be adjusted or is set between a blocking position, in which it blocks the recirculation line 24, and an open position, in which it opens up the recirculation line 24. It is advantageous for an exhaust gas cooler 26 also to be arranged in the recirculation line 24.

All of the actuating elements of the various adjustable components, in particular the variable turbine geometry 8, the bypass valve 22 and if appropriate the blocking valve 25, are adjusted to their desired position by means of actuating signals which can be generated in a control device 27.

When the internal combustion engine is operating, the turbine power is transmitted to the compressor 5, which draws in ambient air at pressure p₁ and compresses it to an increased pressure p₂. Downstream of the compressor 5, a charge air cooler 28, through which the compressed air flows, is arranged in the induction section 6. After it has left the charge air cooler 28, the air has been compressed to the boost pressure p_{2S}, at which it is introduced into the cylinder inlet of the internal combustion engine. A separate air introduction to the cylinder groups 19 and 20, allowing selective throttling, for example by line design, is not shown. As a result, for the same power of cylinder groups 19, it is also possible to produce an air/fuel asymmetry. At the cylinder outlet, the exhaust gas back pressure p₃₁ prevails in the first exhaust pipe 17, which is assigned to the first cylinder group 19; the exhaust gas back pressure p₃₂ is present in the second exhaust pipe 18, which is assigned to the second cylinder group 20. In the turbine 3, the exhaust gas is expanded to the low pressure p₄ and is thereafter subjected first of all to catalytic purification and finally blown off into the environment.

In exhaust gas recirculation mode in the fired driving engine mode, the blocking valve 25 of the exhaust gas recirculation device 23 is set to the open position, so that exhaust gas can flow from the first exhaust pipe 17 into the induction section 6. To ensure a pressure gradient which allows exhaust gas recirculation, with an exhaust gas back pressure p₃₁ in the exhaust pipe 17 which exceeds the boost pressure p_{2S}, an asymmetric turbine is used. The variable turbine geometry 8 in the radial turbine inlet cross section 13 of the second flow passage 11 is set to a position in which the desired air quantity is fed to the engine.

A pressure gradient of this type can be boosted by a relatively small first turbine inlet cross section 12 in the first exhaust gas flow 10, adopting a level which, although it may advantageously be slightly greater than the second turbine inlet cross section 13 in the throttling position of the variable turbine geometry, is smaller than this cross section in the open position of the variable turbine geometry. On account of the relatively small first turbine inlet cross section 12, it is possible to achieve a relatively high exhaust gas back pressure p₃₁ in the first exhaust pipe 17. With the exhaust gas recirculation activated, in particular the exhaust gas back pressure p₃₁ in the first exhaust pipe 17 is higher than the exhaust gas back pressure p₃₂ in the second exhaust pipe 18, which is not connected to the exhaust gas recirculation device 23.

In engine braking mode, the variable turbine geometry is shifted to its throttling position, in which the radial turbine inlet cross section 13 is reduced to a minimum level, with the result that the exhaust gas back pressure p₃₂ in the second exhaust pipe 18 rises to a high value, which is in particular greater than the exhaust gas back pressure p₃₁ in the first exhaust pipe 17, which is in communication with the exhaust gas recirculation device 23. As a result, it is possible to achieve very high engine braking powers by greatly increasing the exhaust gas back pressure p₃₂, while it is possible to prevent the critical rotational speed limit of the exhaust gas turbocharger from being exceeded by suitable setting of the valves 22 and 25.

The two cylinder groups 19 and 20 can be operated with different air/fuel ratios. To boost the exhaust gas recirculation, the first cylinder group 19, the exhaust gases from which participate in the exhaust gas recirculation, are operated with a lower air/fuel ratio λₖ with a smaller proportion of air than the second cylinder group 20, which accordingly has a higher air/fuel ratio λ_{g} with a higher proportion of air, the exhaust gases from which second cylinder group, with the bypass valve 22 blocked, do not participate in the exhaust gas recirculation. In an advantageous embodiment, the value of the air/fuel ratio λₖ of the cylinder group 19 involved in the exhaust gas recirculation, given a suitable exhaust gas purification system, is below the stoichiometric value, whereas the value of the air/fuel ratio λ_{g} of the second cylinder group 20 is above the stoichiometric value. The lower proportion of air in the air/fuel ratio λₖ of the first cylinder group 19 brings about an in relative terms increased proportion of exhaust gas in the exhaust gases of this cylinder group, which can advantageously be utilized for the exhaust gas recirculation and to influence combustion.

It may be expedient for the internal combustion engine 1 to be designed to be asymmetric, by virtue of the cylinder group 19 involved in the exhaust gas recirculation having a smaller number of cylinders than the second cylinder group 20, which is not directly involved in the exhaust gas recirculation. On account of the different number of cylinders, consumption drawbacks which arise through the lower air/fuel ratio λₖ in the cylinder group 19 can possibly even be overcompensated for by the consumption advantages in the second cylinder group 20 which occur as a result of the higher proportion of air in the air/fuel ratio λ_{g}.

It is expedient for the air/fuel ratio of each cylinder group to be set by means of a correspondingly metered fuel injection quantity. In this embodiment, the air supply in the induction section can be maintained unchanged. According to an alternative embodiment, however, it may also be expedient, in addition or as an alternative to altering the injection quantity, also to suitably adapt the air quantity to be fed to each cylinder group.

With the two-flow exhaust gas turbine 3 illustrated in FIG. 1, the variable turbine geometry is located in the turbine inlet cross section 13 of the larger exhaust gas flow 11, which is connected to the exhaust pipe 18 that is independent of the exhaust gas recirculation. The turbine inlet cross section 12 of the smaller exhaust gas flow 10, which is connected to the exhaust pipe 17 involved in the exhaust gas recirculation, on the other hand, is designed to be invariable.

Alternative embodiments of exhaust gas turbines 3 are illustrated in FIGS. 2 and 3. According to FIG. 2, there is provision for the variable turbine geometry 8 to extend over both turbine inlet cross sections 12 and 13, so that each turbine inlet cross section 12 and 13 can be altered by adjusting the variable turbine geometry 8. This is advantageous in particular for setting the quantity of exhaust gas to be recirculated, since adjusting the variable turbine geometry allows the exhaust gas back pressure in the first exhaust gas flow 10 and the first exhaust pipe 17 to be altered, and therefore allows the pressure gradient between exhaust pipe 17 and induction section to be altered.

Instead of a simple axial slide turbine, which is utilized predominantly for the turbine braking function, rotor blade turbines are more expedient for the exhaust gas recirculation function.

According to FIG. 3, there is provision for the variable turbine geometry 8 to extend only into the region of the turbine inlet cross section 12 of the first exhaust gas flow 10 involved in the exhaust gas recirculation. By contrast, there is no variable turbine geometry in the second turbine inlet cross section 13 of the second exhaust gas flow 11. As a result, it is possible to set the recirculated exhaust gas quantity by adjusting the variable turbine geometry, the adjustment in the variable turbine geometry acting only indirectly on the pressure in the second exhaust gas flow 11.

The graph presented in FIG. 4 shows various pressure profiles, illustrated for a symmetric engine operating mode and for an asymmetric engine operating mode, as a function of the engine speed n_{M} of the internal combustion engine. The graph plots the boost pressure p_{2S} in the induction section, the exhaust gas pressures p₃₁^{sy} and p₃₂^{sy} in the two exhaust pipes of the two cylinder groups in symmetric operating mode (both cylinder groups have the same power output) and the exhaust gas pressures p₃₁^{sy} and p₃₂^{sy} in the two exhaust pipes of the two cylinder groups in asymmetric operating mode (different power output in the cylinder groups on account of different designs and/or different operating modes with fired driving).

Over the entire spectrum of the engine speed n_{M}, the exhaust gas pressure p₃₁^{sy} or p₃₁^{asy} which is present in the exhaust pipe of the smaller turbine flow is above the boost pressure p_{2S} in the induction section, whereas the exhaust gas pressure p₃₂^{sy} or p₃₂^{asy} which is present in the exhaust pipe supplying the larger exhaust gas flow is below the boost pressure p_{2S}. However, there are differences between the pressures for the symmetric operating mode and the asymmetric operating mode. In the lower engine speed range—below a limit engine speed n_{M}^{o}—the values for the asymmetric operating mode are further away from the boost pressure p_{2S} than for the symmetric operating mode, with the consequence that in asymmetric operating mode a higher exhaust gas pressure p₃₁^{asy} can be achieved in the exhaust pipe assigned to the smaller exhaust gas flow than in symmetric operating mode, in which the exhaust gas pressure p₃₁^{sy} is present in this pipe, whereas in the exhaust pipe assigned to the larger exhaust gas flow the pressure p₃₂^{asy} in asymmetric operating mode is lower than in symmetric operating mode (exhaust gas pressure p₃₂^{sy}). Above the limit engine speed n_{M}^{o}, depending on the asymmetric mode (cf. FIG. 6), however, these conditions may be reversed, so that the exhaust gas recirculation can be set appropriately above this engine speed. Therefore, above the limit engine speed n_{M}^{o} it may be appropriate to revert to symmetric operating mode.

Corresponding conditions can also be discerned from FIGS. 5 and 6. FIG. 5 shows a graph presenting the exhaust gas recirculation rate EGR^{asy} of the exhaust pipe involved in the exhaust gas recirculation in asymmetric operating mode compared to the corresponding exhaust gas recirculation rate EGR^{sy} in symmetric operating mode, plotted as a function of the engine speed n_{M}^{o}. Below the limit engine speed n_{M}^{o}, the exhaust gas recirculation rate EGR^{asy} in asymmetric operating mode is higher than the exhaust gas recirculation rate EGR^{sy} for the symmetric operating mode. The conditions are reversed above the limit engine speed nₘ^{o}.

FIG. 6 shows a graph illustrating the power deviation LD in the cylinder groups in asymmetric operating mode compared to the symmetric operating mode as a function of the engine speed n_{M}. The power values ‘19^{’sy} and ‘20^{’sy} for the two cylinder groups 19 and 20 illustrated in FIG. 1 in symmetric operating mode, marking a mean value, are plotted as a horizontal line. The power outputs deviate with respect to these mean values in asymmetric operating mode in the positive and negative directions in accordance with the respective plotted curves ‘19^{’asy} and ‘20^{’asy}. The cylinder group involved in the exhaust gas recirculation outputs a higher power below the limit engine speed n_{M}^{o} than the associated values for the symmetric operating mode, whereas the cylinder group which is not involved in the exhaust gas recirculation generates a lower power. These conditions are reversed above the limit engine speed n_{M}^{o}.

With the internal combustion engine and method described, it is possible to increase the exhaust gas recirculation rate in the lower engine speed range. Thermal and mechanical stresses are reduced in the upper engine speed range. To optimize smooth running of the engine, it may be appropriate for the crankshaft to be adapted to the asymmetric engine operating mode. The degree of asymmetry in the power generation of the two cylinder groups expediently deviates by at most 20%, but in particular at most 15%, from the associated values for a symmetric operating mode or design.

If appropriate, a respective crankshaft can be provided for each cylinder group, with the result that higher power offsets between the cylinder groups and accordingly higher degrees of asymmetry can be realized.

1-17. (canceled)

18. An internal combustion engine having an exhaust gas recirculation device and cylinder groups, whereby exhaust gas from each cylinder group is dischargeable separately via respective exhaust pipes, wherein a recirculation line of the exhaust gas recirculation device branches and opens out into an induction section of the internal combustion engine and the cylinder groups are arranged to be operated with an identical or different power output, and the recirculation line branches off from one of the exhaust operateable with a higher power output in at least one operating point.

19. The internal combustion engine as claimed in claim 18, wherein specific power of cylinders of one cylinder group differs from specific power of the cylinders of another cylinder group.

20. The internal combustion engine as claimed in claim 18, wherein the cylinder groups comprise a different number of cylinders.

21. The internal combustion engine as claimed in claim 18, wherein an exhaust gas turbine of an exhaust gas turbocharger is operatively arranged in the exhaust section such that the exhaust pipes are feedable to the exhaust gas turbine.

22. The internal combustion engine as claimed in claim 21, wherein the exhaust gas turbine is of two-flow configuration, with each exhaust gas flow of the exhaust gas turbine being operatively connected to a respective one of the exhaust pipes.

23. The internal combustion engine as claimed in claim 22, wherein exhaust gas flows are of different sizes, a smaller of the exhaust gas flows being connected to the exhaust pipe associated with the exhaust gas recirculation device.

24. The internal combustion engine as claimed in claim 21, wherein the exhaust gas turbine has a variable turbine geometry arrangement for adjustably setting an active turbine inlet cross-section.

25. The internal combustion engine as claimed in claim 22, wherein the variable turbine geometry arrangement in association with a turbine inlet cross-section of each of the exhaust gas flows.

26. The internal combustion engine as claimed in claim 22, wherein the variable turbine geometry arrangement is associated with the turbine inlet cross-section of the exhaust gas flow associated with the exhaust gas recirculation device.

27. An internal combustion engine having an exhaust gas recirculation device and cylinder groups, in which exhaust gas from each cylinder group is dischargeable separately via respective exhaust pipes, comprising a recirculation line of the exhaust gas recirculation device branches and opens out into an induction section of the internal combustion engine, and the cylinder groups are arranged to be selectively operated with an identical or different power output,
wherein the cylinder groups are operateable with different air/fuel ratios, and the recirculation line exhaust gas recirculation device branches off from one of the exhaust pipes associated with the cylinder group operateable with a lower air/fuel ratio in at least one operating point.

28. The internal combustion engine as claimed in claim 27, wherein the cylinder group associated with the exhaust gas recirculation device comprises a smaller number of cylinders than another cylinder group which is independent of the exhaust gas recirculation device.

29. The internal combustion engine as claimed in claim 27, wherein an exhaust gas turbine of an exhaust gas turbocharger is operatively arranged in the exhaust section such that the exhaust pipes as feedable to the exhaust gas turbine.

30. The internal combustion engine as claimed in claim 29, wherein the exhaust gas turbine is of two-flow configuration, with each exhaust gas flow of the exhaust gas turbine being operatively connected to respectively one of the exhaust pipes.

31. The internal combustion engine as claimed in claim 30, wherein exhaust gas flows are of different sizes, a smaller exhaust gas flows being connected to the exhaust pipe associated with the exhaust gas recirculation device.

32. The internal combustion engine as claimed in claim 29, wherein the exhaust gas turbine has a variable turbine geometry arrangement for adjustably setting an active turbine inlet cross-section.

33. The internal combustion engine as claimed in claim 30, wherein the variable turbine geometry arrangement is associated with the turbine inlet cross-section of the exhaust gas flow associated with the exhaust gas recirculation device.

34. The internal combustion engine as claimed in claim 29, wherein the variable turbine geometry arrangement is associated with the turbine inlet cross-section of the exhaust gas flow associated with the exhaust gas recirculation device.

35. A method for operating an internal combustion engine having an exhaust gas recirculation device and cylinder groups, comprising discharging exhaust gas from each cylinder group separately via a respective exhaust pipe, wherein a recirculation line of the exhaust gas recirculation device branches off from one of the exhaust pipes and opens into an induction section of the internal combustion engine, and selectively operating the cylinder groups with an identical or different power output, such that one of the cylinder groups, whose exhaust pipe is connected to the recirculation line is operated with a variable power output.

36. The method as claimed in claim 35, wherein the cylinder groups are operateable with different air/fuel ratios, and the cylinder group whose exhaust pipe is connected to the recirculation line is operateable with a variable air/fuel ratio.

37. The method as claimed in claim 36, wherein the air/fuel ratio is reduced by increasing a fuel proportion.

38. The method as claimed in claim 35, wherein different ignition points are set in the cylinder groups.

39. The method as claimed in claim 35, wherein different fuel injection profiles are set in the cylinder groups.

40. The method as claimed in claim 35, wherein an air proportion is reduced to decrease the air/fuel ratio.
